(19) United States
(12) Patent Application Publication
(10) Pub. No.: US 2012/0131432 A1
(43) Pub. Date: May 24, 2012

(54) SYSTEMS AND METHODS FOR DELTA ENCODING, TRANSMISSION AND DECODING OF HTML FORMS

(76) Inventors: EDWARD WAYNE GODDARD, Calgary (CA); Mircea Toma, Medias (RO); Kenneth W. Fyten, Airdrie (CA)

(21) Appl. No.: 12/954,496

(22) Filed: Nov. 24, 2010

(51) Int. Cl. G06F 17/00

(52) U.S. Cl. 715/221

(57) ABSTRACT

A system comprising a Web Browser that performs delta encoding of HTML form data for HTML form submission over HTTP, and a Web Server that performs delta decoding of delta encoded HTML form data received over HTTP from the Web Browser, where delta encoding comprises encoding only HTML form elements that are changed by the user prior to submission of the HTML form, and delta decoding comprises reconstituting the complete form data using the delta encoded HTML form submission received over HTTP.

### BACKGROUND

1. Field

This disclosure relates to HTML form encoding, transmission and decoding, and more specifically to delta encoding, and delta decoding of HTML forms.

2. Background

The World Wide Web is based on a client/server architecture where client computers run Web Browser (“Browser”) software applications that fetch web pages from Web Server (“Server”) computers, which in turn provide the requested web page, and process user input that may be submitted from the Browser. An Internet protocol called Hypertext Transmission Protocol (HTTP) is used to facilitate the communication between client and server computers.

Hypertext Markup Language (HTML) is typically used to define the content of a Web page, and a Web Browser is a software application capable of fetching HTML web pages using a HTTP GET request, and rendering the content of the Web page on the computer screen for the user to view and interact with.

User interaction with a Web page displayed in a Browser typically involves manipulation of one or more Browser controls capable of accepting user input. Browser input controls take various forms like text input elements, radio buttons, check boxes, and buttons, but have the common feature of accepting some form of input from the user.

Typically, user input in a Web page is submitted over HTTP to a Server capable of processing the input in some application-specific way. For HTML, a <form> tag is used to organize a group of Browser input controls for submission to the Server for processing. When a form is submitted by the Browser, it is encoded in some content-specific way into a stream of transmittable characters, and transmitted to the server, typically using an HTTP POST request. The server receives the encoded form in the HTTP POST request, decodes it in the same content-specific way to retrieve the user input form data for subsequent application-specific processing.

If an HTML form contains a large number of Browser input controls, the encoding/transmission/decoding process may be time consuming and can reduce performance and response time. Encoding of the form requires client computing resources, decoding of the form requires server computing resources, and transmission of the form requires network bandwidth.

In the case where a user is interacting with the same form data over multiple form submissions, and that form is large, often the user will interact with only a small number of controls in the form between form submissions, leaving a majority of the controls in the same state they were in the previous submission. Even though a small amount of user data has changed, the complete form must be encoded, transmitted and decoded each time. A means of encoding/transmitting/decoding only the changed user data (the delta) can significantly reduce network bandwidth requirements, and improve overall responsiveness of the system.

### SUMMARY

The following presents a simplified summary of one or more aspects of the invention in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to various aspects, the subject invention relates to a data transmission system having at least one processor; and a memory coupled to the at least one processor, the memory having instructions stored thereon configured to cause the at least one processor to receive delta encoded HTML form data from an HTML form submission over HTTP, wherein the delta encoded HTML form data comprises an encoded version of only HTML form elements of a complete HTML form that are changed by a user prior to the HTML form submission; and reconstitute the complete HTML form using the delta encoded HTML form data.

The subject invention further relates to a method including the steps of receiving delta encoded HTML form data from an HTML form submission over HTTP, wherein the delta encoded HTML form data comprises an encoded version of only HTML form elements of a complete HTML form that are changed by a user prior to the HTML form submission; and reconstituting the complete HTML form using the delta encoded HTML form data.

The subject invention further relates to a computer-program product for communication, including a machine-readable medium encoded with instructions executable to receive delta encoded HTML form data from an HTML form submission over HTTP, wherein the delta encoded HTML form data comprises an encoded version of only HTML form elements of a complete HTML form that are changed by a user prior to the HTML form submission; and reconstitute the complete HTML form using the delta encoded HTML form data.

The subject invention further relates to an apparatus having means for receiving delta encoded HTML form data from an HTML form submission over HTTP, wherein the delta encoded HTML form data comprises an encoded version of only HTML form elements of a complete HTML form that are changed by a user prior to the HTML form submission; and means for reconstituting the complete HTML form using the delta encoded HTML form data.

### BRIEF DESCRIPTION OF DRAWINGS

Aspects of the disclosures herein are illustrated by way of example, and not by way of limitation, in the accompanying drawings, wherein:

FIG. 1 is a source code listing of an HTML page contained in an HTML form containing three (3) input controls from a browser.

FIG. 2 illustrates contents of the HTML page from FIG. 1 after an initial rendering by the browser.

FIG. 3 illustrates contents of the HTML page from FIG. 1 after a user has interacted with the input controls in the HTML form.

FIG. 4 illustrates network traffic associated with posting of the HTML form as illustrated in FIG. 3.

FIG. 5 illustrates contents of the HTML page from FIG. 3 after the user has interacted with the second input controls prior to a second form submission.

FIG. 6 illustrates network traffic associated with the second posting of the HTML form as illustrated in FIG. 5.

FIG. 7 illustrates a standard HTML form encoding, transmission, decoding and processing mechanism.

FIG. 8 illustrates a delta form encoding, transmission, decoding, and processing mechanism configured in accordance with one embodiment of the present invention.

FIG. 9 illustrates delta form decoding logic configured in accordance with one embodiment of the present invention.

FIG. 10 illustrates changes in HTML code from FIG. 1 needed to include delta form decoding logic illustrated in FIG. 9.

FIG. 11 illustrates delta form encoding logic based on form data preservation configured in accordance with one embodiment of the present invention.

FIG. 12 illustrates changes in HTML code from FIG. 10 needed to include value change detection and marking configured in accordance with one embodiment of the present invention.

FIG. 13 illustrates delta form encoding logic based on value change detection and marking as illustrated in FIG. 12 configured in accordance with one embodiment of the present invention.

FIG. 14 illustrates network traffic associated with the second posting of the form as illustrated in FIG. 5 using the delta form encoding logic configured in accordance with one embodiment of the present invention.

FIG. 15 is a conceptual block diagram illustrating an example of an implementation for an application server.

### DETAILED DESCRIPTION

The detailed description set forth below in connection with the appended drawings is intended as a description of various embodiments of the teachings herein and is not intended to represent the only embodiments in which the teachings herein may be practiced. Each embodiment described in this disclosure is provided merely as an example or illustration of the teachings herein, and should not necessarily be construed as preferred or advantageous over other embodiments. The detailed description includes specific details for the purpose of providing a thorough understanding of the teachings. However, it will be apparent to those skilled in the art that the teachings herein may be practiced without these specific details. In some instances, well-known structures and devices are shown in block diagram form in order to avoid obscuring the concepts of the teachings herein. Acronyms and other descriptive terminology may be used merely for convenience and clarity and are not intended to limit the scope of the teachings herein.

In one aspect of the present invention, standard HTML form encoding in a Browser is replaced with delta form encoding, where only form elements that have been changed by the user prior to HTML form submission are encoded and included in the form submission over HTTP to the Server.

In another aspect of the present invention, standard HTML form decoding at the Server is replaced with delta form decoding, where complete HTML form data is reconstituted from delta-encoded HTML form data received from a browser performing delta encoding of HTML form data, and making that complete form data available for application-specific processing.

In yet another aspect of the present invention, delta form decoding logic at the server preserves the state of HTML forms between form submissions, and reconstitutes the compete form data by modifying individual preserved form elements with delta-encoded HTML form values received from a Browser performing delta encoding of HTML form submissions.

In yet another aspect of the present invention, delta form encoding, which encodes only HTML form elements that the user has modified prior to submission, is achieved by modifying the implementation of the browser to include delta form encoding logic.

In yet another aspect of the present invention, a standard browser implementation is used, and the HTML page is augmented with JavaScript that performs delta encoding logic, which encodes only HTML form elements that the user has modified prior to submission.

In yet another aspect of the present invention, JavaScript delta encoding logic preserves the state of HTML forms between submissions, compares preserved form element values with corresponding submitted HTML form element values, encodes on those HTML form elements that have changed, and modifies the preserved form state to match the submitted HTML form state.

In yet another aspect of the present invention, JavaScript delta encoding logic includes HTML form element change detection and marking, where HTML form elements are marked as changed, based on JavaScript onChange events, and only marked HTML form elements are encoded for submission to the Server.

In a final aspect of the present invention, application-specific processing of the complete form data occurs normally, with no consideration of the delta form processing that has occurred.

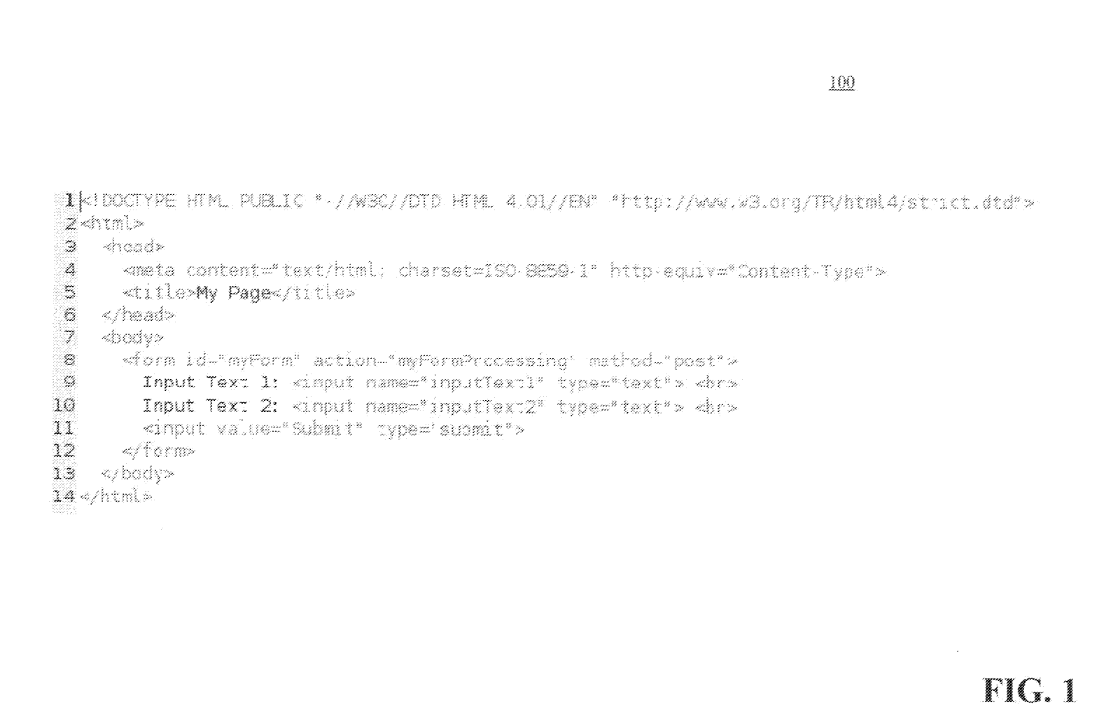

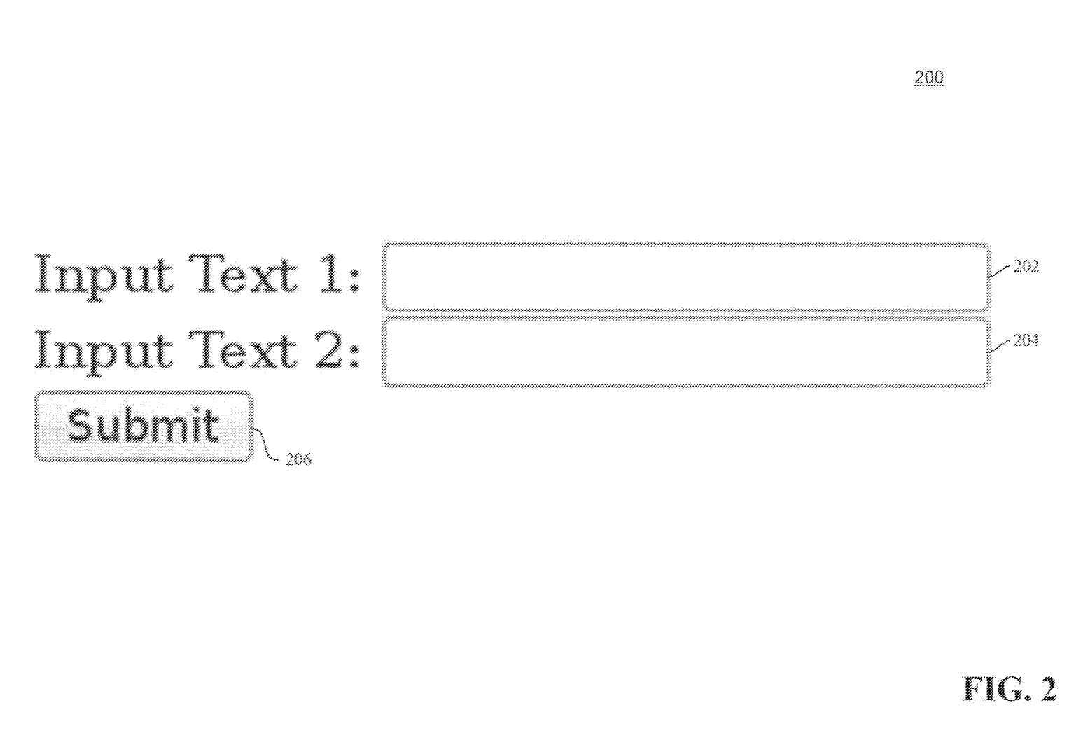

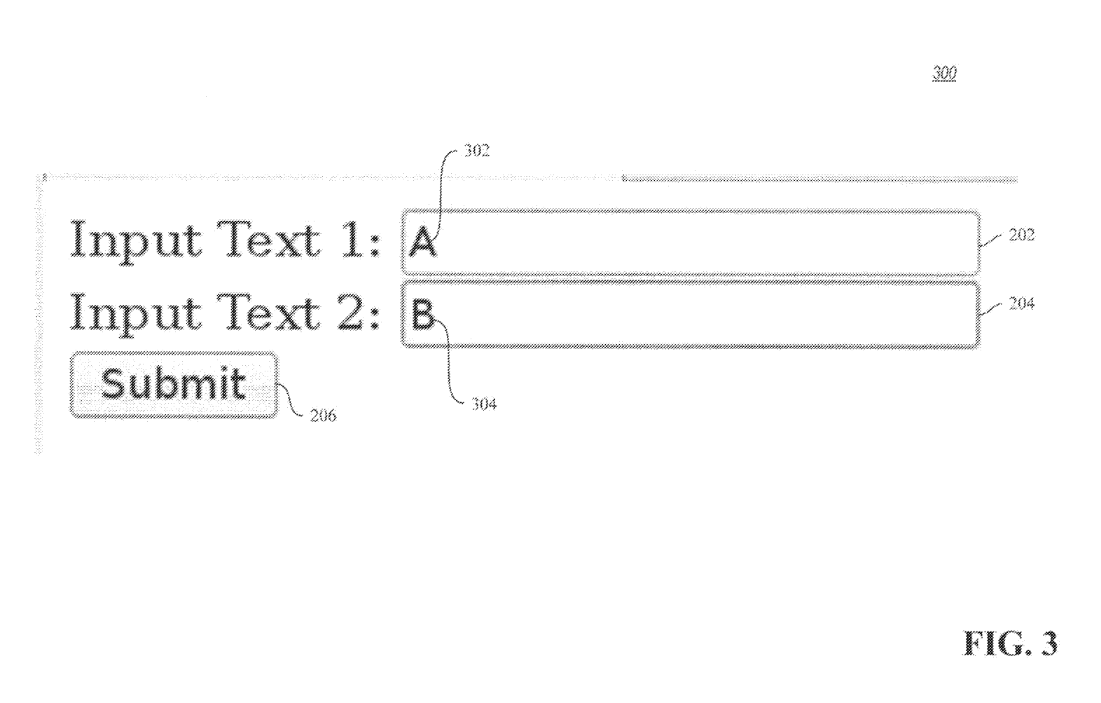

A source code listing 100 for an HTML form contained in an HTML page is illustrated in FIG. 1. Within the HTML page, the HTML form is delimited with <form></form> tags at lines 8 and 12, respectively. The HTML form action=“myFormProcessing” at line 8 specifies a relative URL from a fully-qualified URL of an HTML page to which the HTML form will be submitted, and method=“post” at line 8 specifies that the HTML form will be submitted with an HTTP POST operation. The HTML form contains three input controls—two input text elements at lines 9 and 10, and a submit button at line 11. A rendering 200 of this HTML page in a browser is illustrated in FIG. 2. After the user interacts with the HTML page to enter text into text element comprising of a first text element field 202 (“Input Text 1”) and a second text element field 204 (“Input Text 2”) and clicks on a “Submit” button 206, the HTML page will look like an updated rendering in 300 FIG. 3. In this case, the user has entered an “A” 302 in the first text element 202, and a “B” 304 in the second text element 204.

Returning again to FIG. 1, line 4 contains a <meta> tag defining the content type of the page—specifically content=“text/html; charset=ISO-8859-1”. This indicates to the browser how to interpret content in the page, and how the browser should encode the form when it is submitted by the user. Upon submission, the browser will encode the form, and perform an HTTP POST operation of the encoded form content.

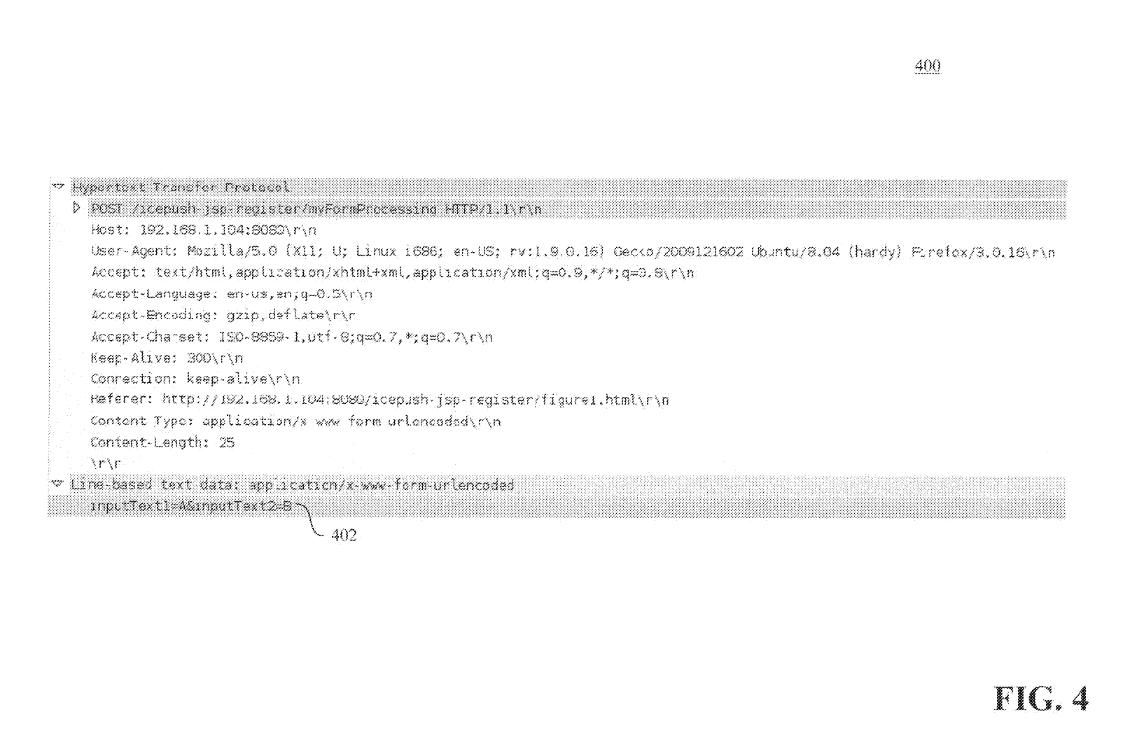

FIG. 4 illustrates network traffic 400 associated with the HTTP POST operation. In the last line of FIG. 4, the actual encoded content of the form is illustrated. The exact encoding is “inputText1=A&inputText2=B” 402, representing user input text elements inputText1 and inputText2 containing values “A” 302 and “B” 304 respectively, as illustrated in FIG. 3.

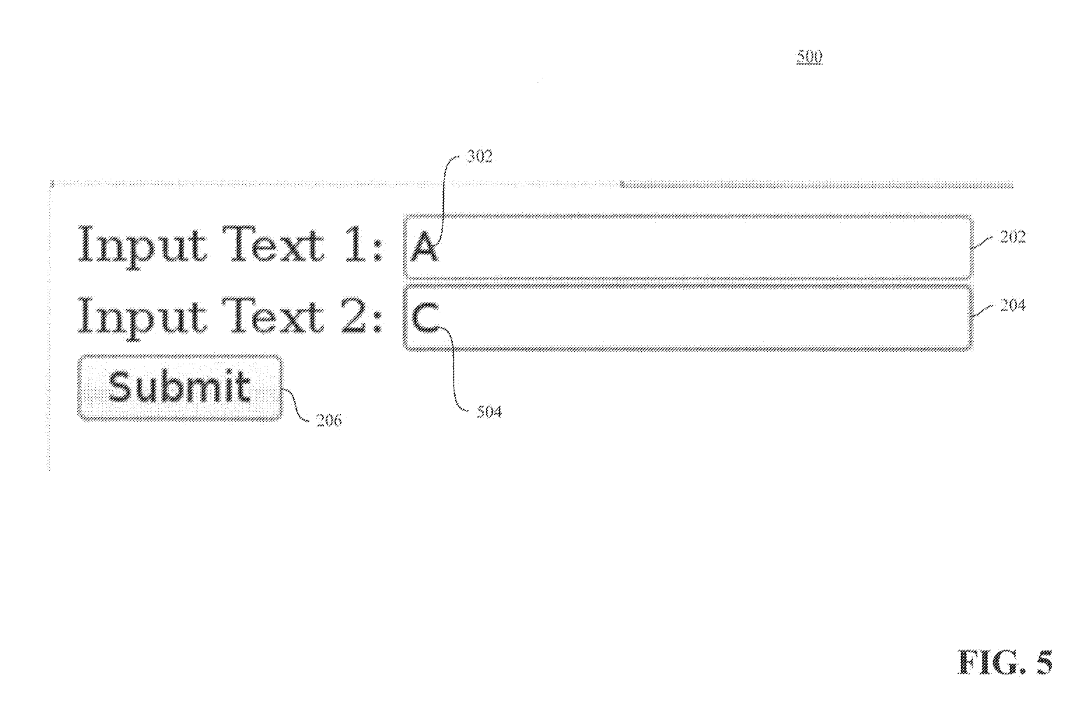

If server-side processing of the posted form results in the same page being returned to the browser with the users text entries unchanged from the previous POST operation, the user could decide to modify only one of the text elements and then resubmit the form. In a case that the second input text element 204 is modified from a “B” 304 to a “C” 504, the HTML page would appear as illustrated by a changed rendering 500 in FIG. 5. Currently, when the form is resubmitted in this state, the entire form is encoded again and posted to the server.

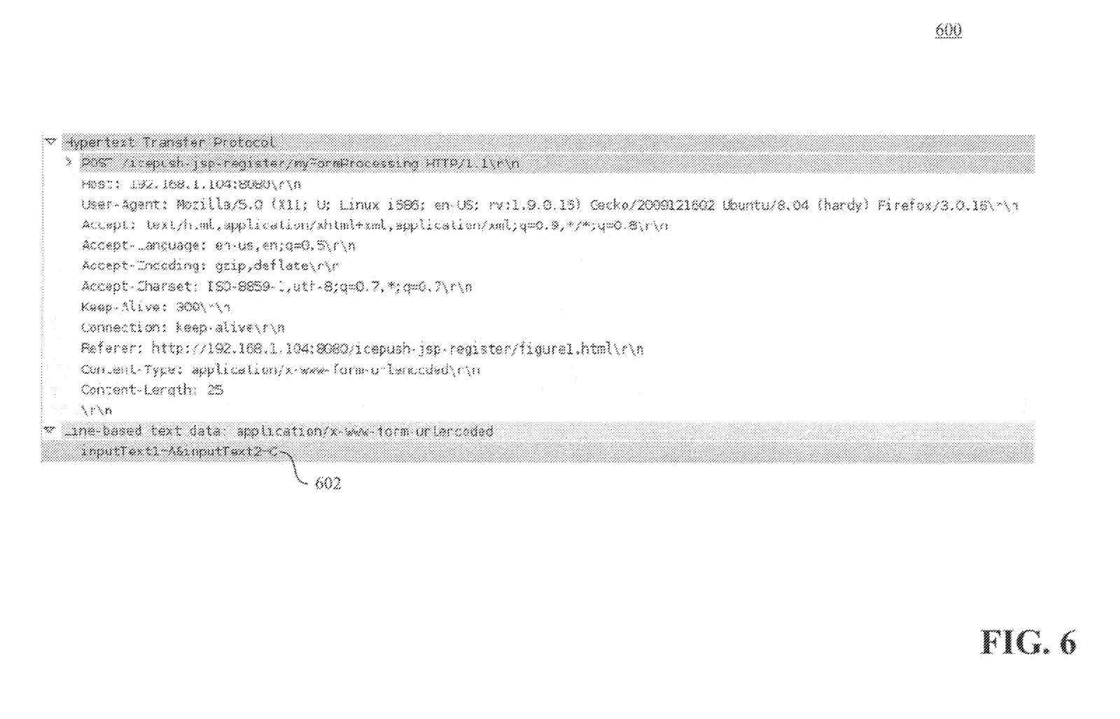

FIG. 6 illustrates network traffic 600 associated with this second POST operation. Again, the last line illustrates the encoding that occurs, specifically “inputText1=A&inputText2=C” 602, which represents a complete encoding of the form, containing values for all input controls—regardless of whether they changed from the first to the second submission.

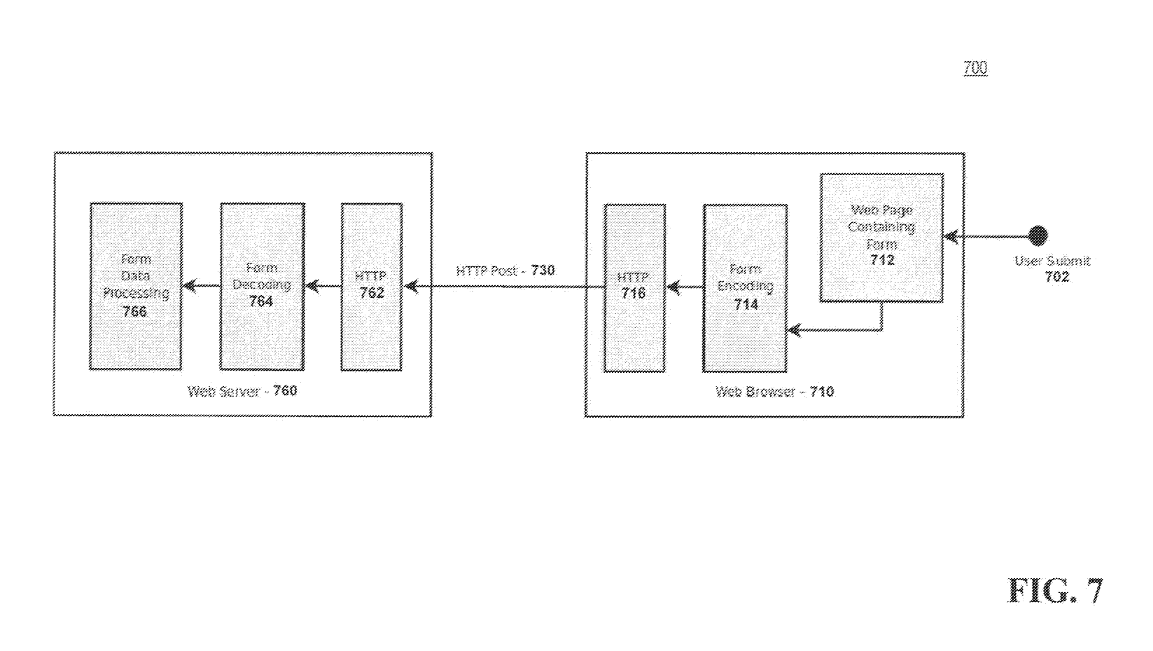

A standard process 700 for form submission, encoding, transmission, decoding, and data processing is illustrated in FIG. 7. At 702, a user interacts with a Web Browser 700 displaying a Web Page 712 containing a form, and causes that form to be submitted. Upon submission, the Browser 710, encodes the form using Form Encoding logic 714, and generates an HTTP POST request using HTTP logic 716. The request is transmitted to the Web Server 760 using an HTTP POST operation 730. HTTP logic 762 will receive the HTTP POST request, and pass the request to Form Decoding logic 764 for decoding before the decoded form data is processed in an application-specific way at Form Data Processing logic 766.

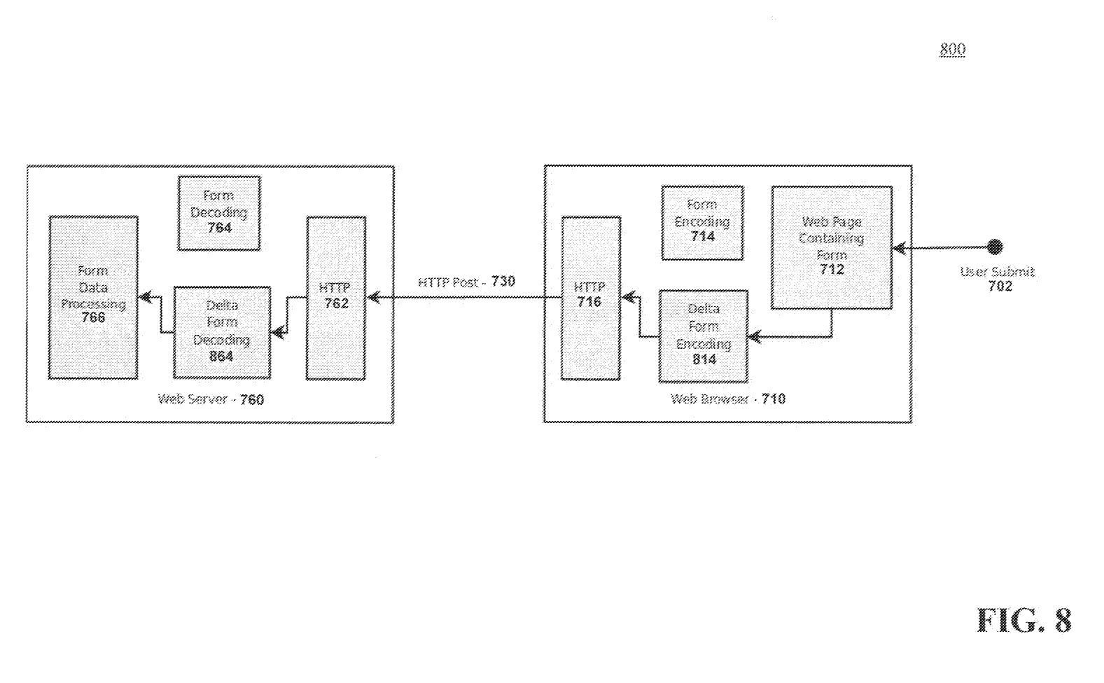

In one embodiment of the present invention, the standard process 700 for form encoding and decoding, as illustrated in FIG. 7, is replaced with a delta form encoding and decoding process 800 as illustrated in FIG. 8. Form Encoding 714 is bypassed in favor of Delta Form Encoding 844 at the Web Browser 710. Likewise, Form Decoding 764 is bypassed in favor of Delta Form Decoding 864 at the Web Server 760.

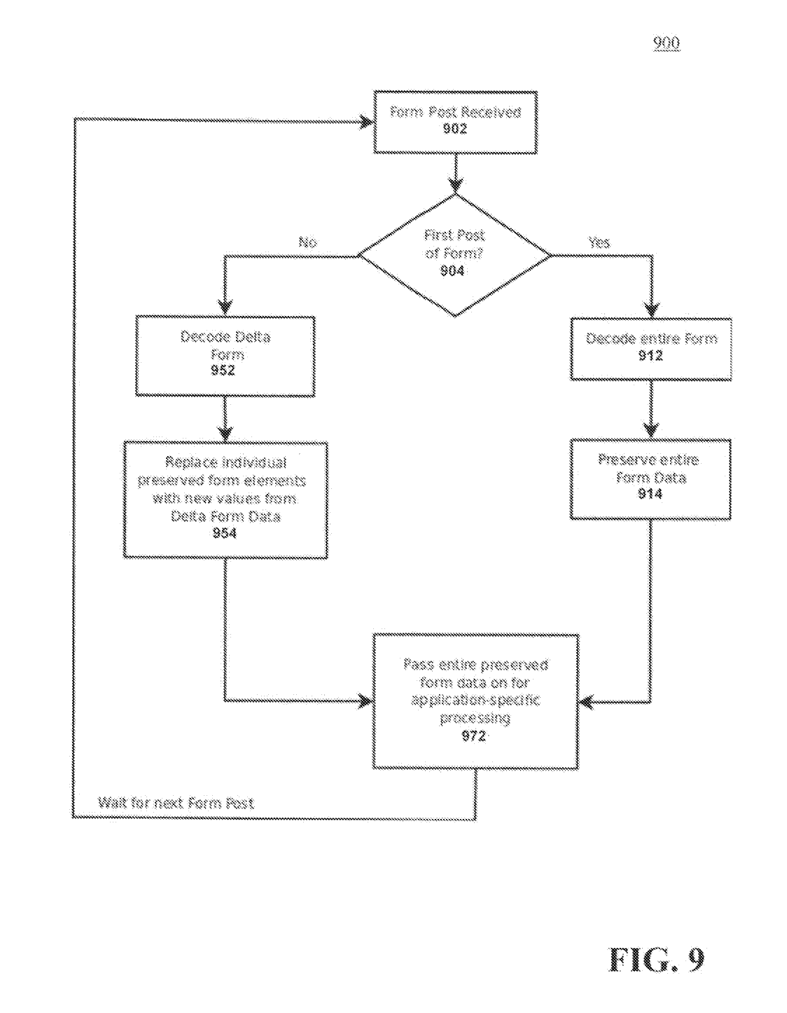

For delta form decoding, it is necessary to preserve the state of the HTML form between form submissions. In one embodiment of the present invention, a Document Object Model (DOM) representing the HTML page is preserved at the Server, and this DOM contains the preserved HTML form data. Other embodiments for preserving the form data are possible. A delta form decoding process 900 is illustrated in FIG. 9. At step 902, a Form Post is received. At step 904, the existence of preserved form data indicates the HTML form has been processed previously. If no such preserved form data exists for the HTML form, then decoding of the entire form occurs at step 912, and decoded form data is preserved at step 914. If preserved form data exists at step 914, then the form contents are decoded at step 952, and individual form element values in the preserved form data are replaced with the newly decoded form data at step 954. In either case, at step 972, the complete form data is preserved and available for application-specific processing.

Turning now to delta form encoding, in one embodiment of the present invention, the browser implementation is modified to incorporate delta form processing logic. This embodiment utilizes custom implementations for each type of browser (e.g., Internet Explorer™, Firefox™, . . . ), and the modified browser implementation must be made available to the users, which may not be convenient or allowable. While achievable, this embodiment is not as preferable for general distribution to World Wide Web users.

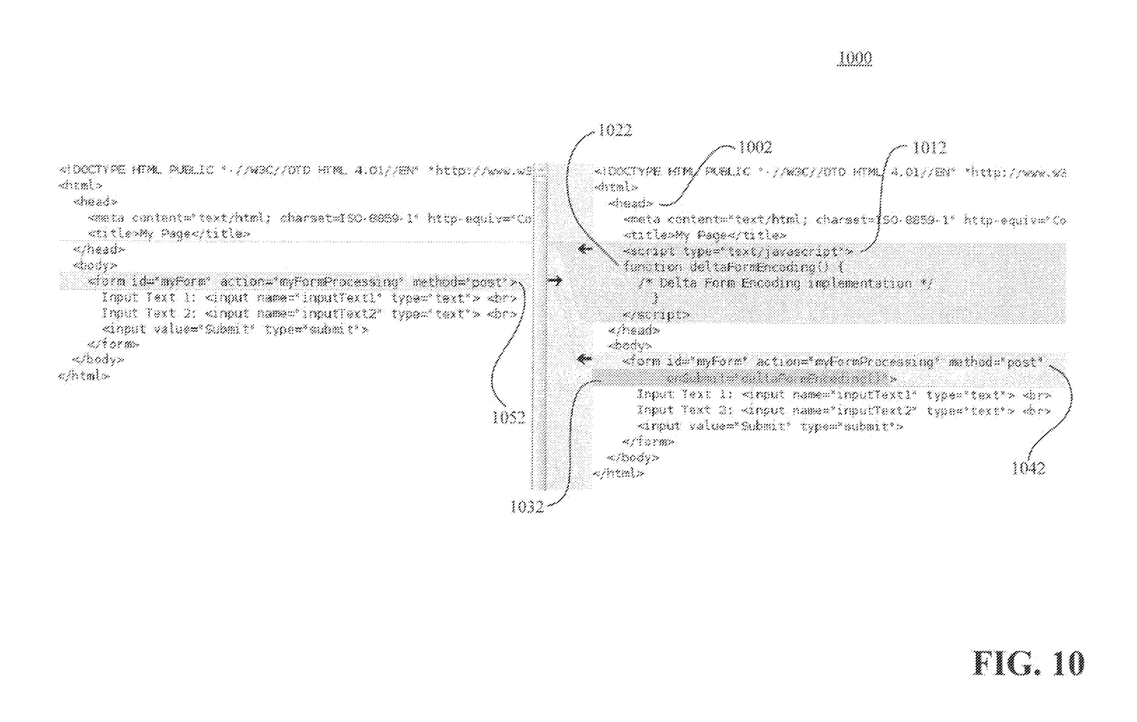

In another embodiment of the present invention, delta form encoding is implemented using the JavaScript language that is included with the HTML page, and requires no modification to the browser implementation itself In this embodiment, a JavaScript “onSubmit( )” event is registered with the HTML form, and a JavaScript function that implements delta form encoding executes when the user submits the HTML form. The modifications to the HTML page in FIG. 1 are illustrated in a listing 1000 in FIG. 10. Specifically, a <script> tag 1012 is added to the page <head> tag 1002 containing a deltaFormEncoding( ) function 1022 for executing delta form encoding logic, and an onSubmit attribute 1032 is added to a <form> tag 1042 that will cause the JavaScript deltaFormEncoding( ) function 1022 to execute when the user submits the form by submitting a POST request in a <form> tag 1052.

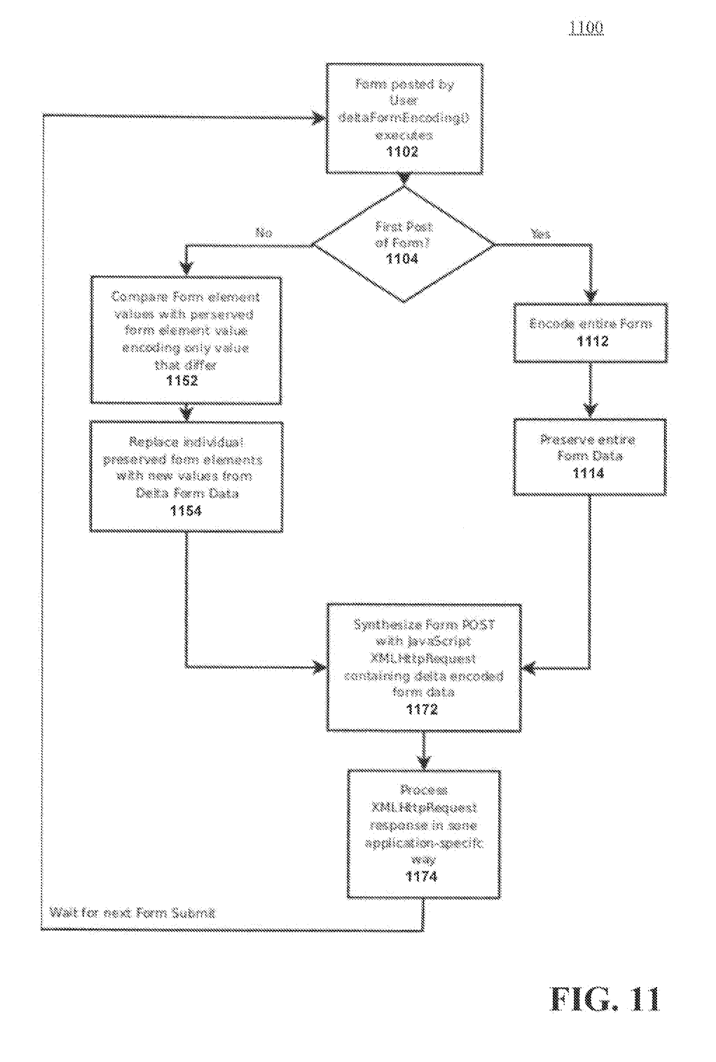

In one embodiment of the present invention, the JavaScript delta form encoding logic preserves the entire state of the form between submissions. The logic contained in the deltaFormEncoding( ) function 1022 is illustrated in a process 1100 in FIG. 11. At step 1102, the user submits the form, causing the onSubmit event to occur, resulting in the execution of the deltaFormEncoding( ) function 1022. If preserved form data does not exist at step 1104, then the entire form is encoded at step 1112 and the entire form data is preserved at step 1114. If preserved form data does exist at step 1104, then form element values are compared with preserved form element values, and only those values that differ are encoded at step 1152. Newly encoded form values are then preserved at step 1154 for future delta encodings. In either case, at step 1172 a form post is synthesized with a JavaScript “XMLHttpRequest” containing the delta encoded form values, and the form is posted to the server for delta decoding. At step 1174, the response to the XMLHttpRequest is received and processed in an application-specific fashion. Typically, this response will include modified content to be displayed in the browser page.

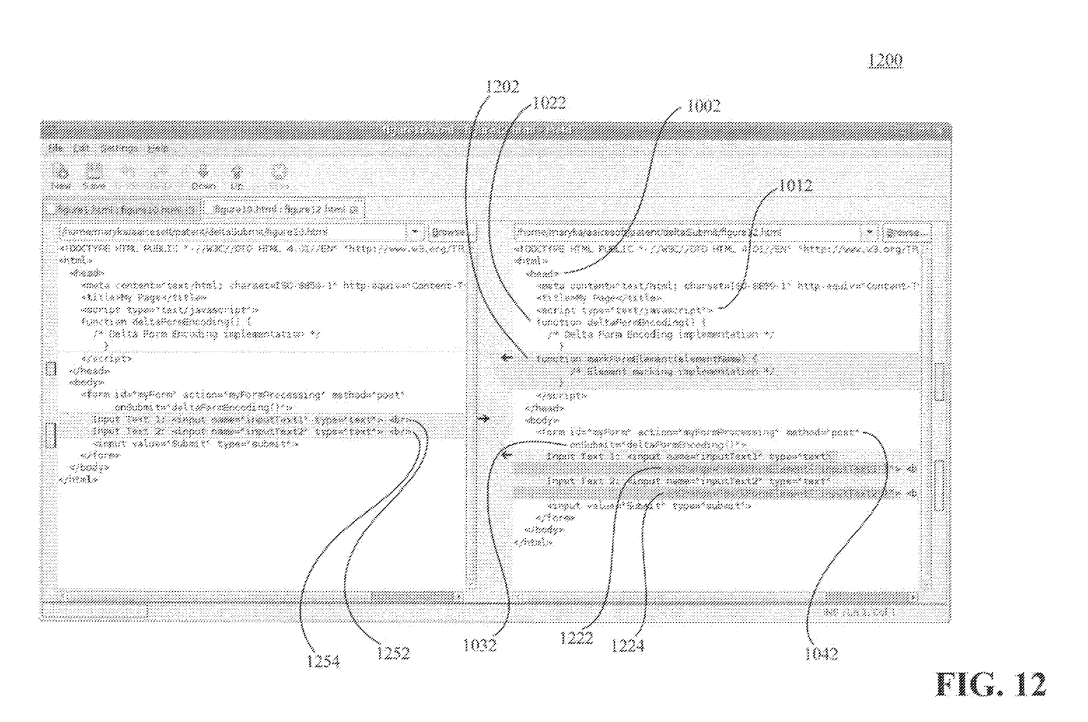

In another embodiment of the present invention, the JavaScript delta form encoding logic marks any form elements that have changed from the last submission, and encodes only those elements in the synthesized form POST. In this embodiment, each element in the form includes change detection logic capable of marking an element for encoding when the element changes. Also in this embodiment, marking of change elements involves creating a list of HTML form elements that have changed. Returning to the modified HTML page, as illustrated in FIG. 10, individual form elements are augmented with change detection logic as illustrated in a listing 1200 in FIG. 12. Specifically, another JavaScript function, a markFormelement( ) function 1202 is added, and onChange attributes 1222, 1224 are added to inputText1 and inputText2 form elements 1252, 1254 that cause the markFormelement( ) function 1202 to execute when the user changes the form element value.

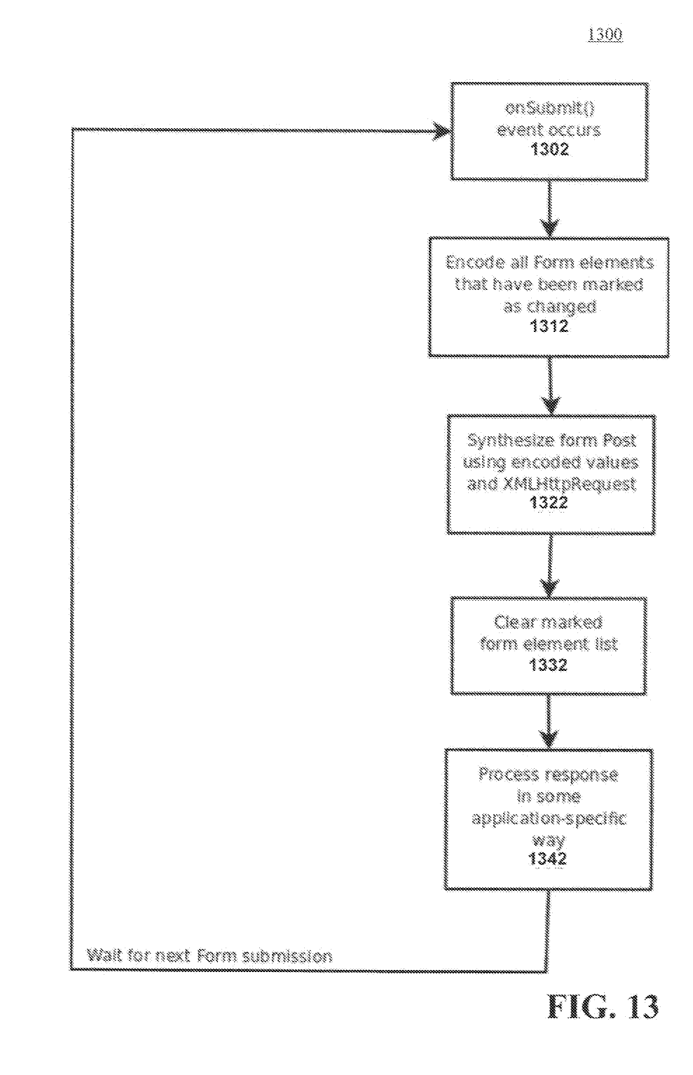

A delta form encoding logic 1300 that embodies the delta form encoding logic 814 in one aspect of the invention is illustrated in FIG. 13. At step 1302, the user submits the HTML form, causing the onSubmit event to occur, resulting in the execution of the deltaFormEncoding( ) function. At step 1312, all marked form element values are encoded, and at step 1322, a form post is synthesize with a JavaScript XMLHttpRequest containing the delta encoded form values, and the form is posted to the server for delta decoding. At step 1332, the list of marked element is cleared, and at step 1342, the response to the XMLHttpRequest is received and processed in some application-specific way.

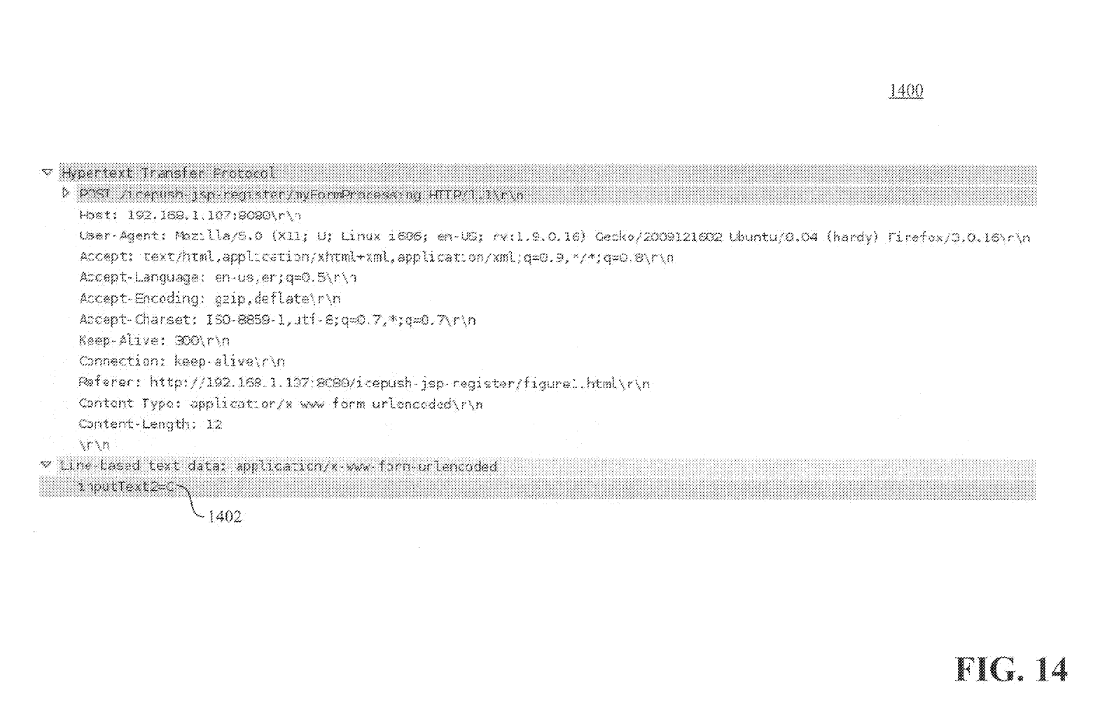

Returning now to the original example of multiple form submissions as illustrated in FIGS. 3 and 5, but now in the presence of the present invention. On the first form submission, as illustrated in FIG. 3, the HTML form will be completely encoded and posted to the server as illustrated in FIG. 4. On the second submission, delta form encoding/decoding will occur and only InputText2 will be encoded, as illustrated in a listing 1400 in FIG. 14, with the exact encoding being “inputText2=C” 1402.

The functions presented throughout this disclosure may be implemented by any suitable means, whether implemented in hardware, software, or any combination thereof. An example of a software implementation of an application server will now be presented in connection with FIG. 4. However, the present invention is not limited to any specific implementation, and those skilled in the art will be readily able to determine the optimal implementation depending on the particular application and the overall design constraints imposed on the system.

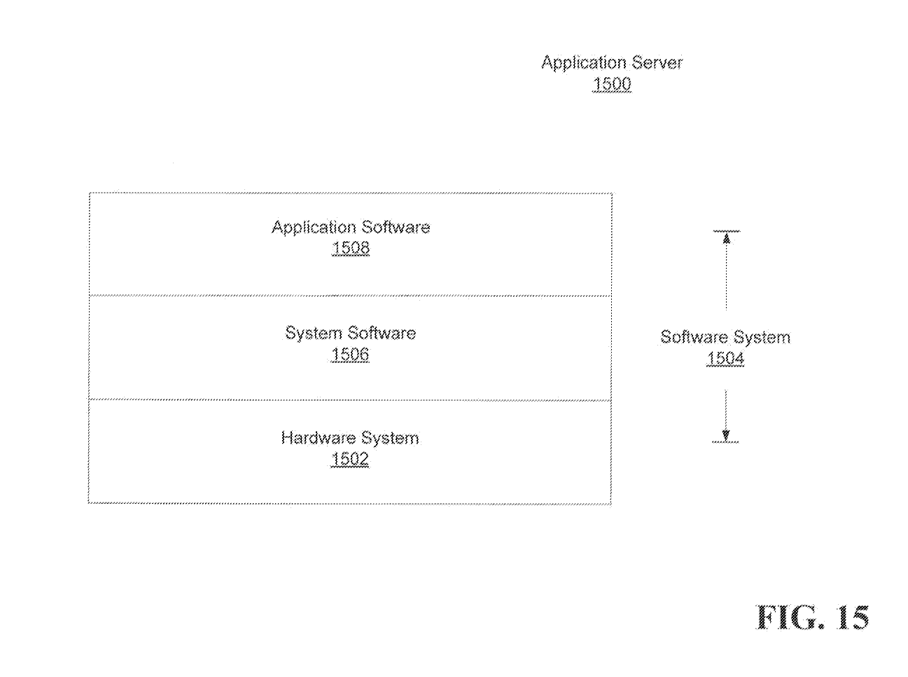

Turning to FIG. 15, a conceptual block diagram illustrating an exemplary implementation of an application server is shown. In this example, the application server 1500 is implemented with a system software 1502 supported by a hardware system 1504. The hardware system 1504 may be configured, by way of example, with a bus architecture that includes any number of interconnecting buses and bridges. The bus architecture may be used to link one or more general-purpose and/or special-purpose processors, machine-readable media, and other supporting circuitry (e.g., timing sources, peripherals, voltage regulators, power management circuits, etc.). Examples of processors include microprocessors, microcontrollers, digital signal processors (DSPs), and other circuitry that can execute software. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be used to store software that collectively, in whole or part, comprises the software system 1502.

The software system 1502 includes system software 1506 and application software 1508. The system software 1506 generally includes low-level programs that operate the hardware system 1504 and provide a platform for running the application software 1508. This includes, by way of example, operating systems, utility programs, compilers, loaders, linkers, debuggers, and other similar programs that interact with the hardware system 1504. The application software 1508 generally includes web applications that process HTTP requests associated with the web applications. The web applications may include one or more notification-enabled applications. In the case where multiple notification-enabled applications are deployed in the application server 1500, the application software 1508 may also include a notification server application to manage access to the shared blocking HTTP connection among the notification-enabled applications. The notification server application includes a long polling mechanism which provides a means for maintaining an open HTTP connection, and a notification server which provides a means for providing an asynchronous notification to one or more notification clients through the open HTTP connection. In the case where a single notification-enabled application is deployed in the application server 1500, the long polling mechanism and the notification server functions may be implemented in the notification-enabled application as described in greater detail above.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A data transmission system comprising:
at least one processor; and
a memory coupled to the at least one processor, the memory comprising instructions stored thereon configured to cause the at least one processor to:
receive delta encoded HTML form data from an HTML form submission over HTTP, wherein the delta encoded HTML form data comprises an encoded version of only HTML form elements of a complete HTML form that are changed by a user prior to the HTML form submission; and
reconstitute the complete HTML form using the delta encoded HTML form data.

2. The system of claim 1, wherein the memory further comprising instructions stored thereon configured to cause the at least one processor to decode the delta encoded HTML form data.

3. The system of claim 1, wherein the memory further comprising instructions stored thereon configured to cause the at least one processor to preserve a state of the complete HTML form between HTML form submissions.

4. The system of claim 3, wherein the memory further comprising instructions stored thereon configured to cause the at least one processor to:
modify the preserved state of the complete HTML form with each delta encoded form element to replace its preserved counterpart so as to reconstitute the complete HTML form; and
make the reconstituted complete HTML form available for application-specific processing.

5. The system of claim 1, wherein the memory further comprising instructions stored thereon configured to cause the at least one processor to transmit a modified HTML page comprising logic for performing delta encoding of HTML forms, wherein only HTML form elements that are changed by the user prior to submission of the HTML form are encoded in the HTML form submission.

6. The system of claim 5, wherein the delta encoding logic comprises code configured to cause a browser on a second processor to:
preserve a state of local HTML form data between HTML form submissions;
compare preserved HTML form elements with their counterpart in the submitted HTML form;
encode only form elements that are different to generate the delta encoded HTML form data; and
transmit the delta encoded HTML form data.

7. The system of claim 6, wherein the delta encoding logic comprises:
change detection and marking logic comprising event handling logic for individual HTML form elements, wherein each changed HTML form element is marked for delta encoding; and
marked HTML form element encoding logic comprising encoding logic for encoding only marked HTML form elements for the HTML form submission.

8. The system of claim 7, wherein the delta encoding logic further comprises clearing of marked state upon HTML form submission.

9. A method comprising:
receiving delta encoded HTML form data from an HTML form submission over HTTP, wherein the delta encoded HTML form data comprises an encoded version of only HTML form elements of a complete HTML form that are changed by a user prior to the HTML form submission; and
reconstituting the complete HTML form using the delta encoded HTML form data.

10. The method of claim 9, further comprising decoding the delta encoded HTML form data.

11. The method of claim 9, further comprising preserving a state of the complete HTML form between HTML form submissions.

12. The method of claim 11, further comprising:
modifying the preserved state of the complete HTML form with each delta encoded form element to replace its preserved counterpart so as to reconstitute the complete HTML form; and
making the reconstituted complete HTML form available for application-specific processing.

13. The method of claim 9, further comprising transmitting a modified HTML page comprising logic for performing delta encoding of HTML forms, wherein only HTML form elements that are changed by the user prior to submission of the HTML form are encoded in the HTML form submission.

14. The method of claim 13, wherein the delta encoding logic comprises code configured to cause a browser to:
preserve a state of local HTML form data between HTML form submissions;
compare preserved HTML form elements with their counterpart in the submitted HTML form;
encode only form elements that are different to generate the delta encoded HTML form data; and
transmit the delta encoded HTML form data.

15. The method of claim 14, wherein the delta encoding logic comprises:
change detection and marking logic comprising event handling logic for individual HTML form elements, wherein each changed HTML form element is marked for delta encoding; and
marked HTML form element encoding logic comprising encoding logic for encoding only marked HTML form elements for the HTML form submission.

16. The method of claim 15, wherein the delta encoding logic further comprises clearing of marked state upon HTML form submission.

17. A computer-program product for communication, comprising:
a machine-readable medium encoded with instructions executable to:
receive delta encoded HTML form data from an HTML form submission over HTTP, wherein the delta encoded HTML form data comprises an encoded version of only HTML form elements of a complete HTML form that are changed by a user prior to the HTML form submission; and
reconstitute the complete HTML form using the delta encoded HTML form data.

18. The computer-program product of claim 17, wherein the machine-readable medium is further encoded with instructions executable to decode the delta encoded HTML form data.

19. The computer-program product of claim 17, wherein the machine-readable medium is further encoded with instructions executable to preserve a state of the complete HTML form between HTML form submissions.

20. The computer-program product of claim 19, wherein the machine-readable medium is further encoded with instructions executable to:
modify the preserved state of the complete HTML form with each delta encoded form element to replace its preserved counterpart so as to reconstitute the complete HTML form; and
make the reconstituted complete HTML form available for application-specific processing.

21. The computer-program product of claim 17, wherein the machine-readable medium is further encoded with instructions executable to transmit a modified HTML page comprising logic for performing delta encoding of HTML forms, wherein only HTML form elements that are changed by the user prior to submission of the HTML form are encoded in the HTML form submission.

22. The computer-program product of claim 21, wherein the delta encoding logic comprises code configured to cause a browser on a second processor to:
preserve a state of local HTML form data between HTML form submissions;
compare preserved HTML form elements with their counterpart in the submitted HTML form;
encode only form elements that are different to generate the delta encoded HTML form data; and
transmit the delta encoded HTML form data.

23. The computer-program product of claim 22, wherein the delta encoding logic comprises:
change detection and marking logic comprising event handling logic for individual HTML form elements, wherein each changed HTML form element is marked for delta encoding; and
marked HTML form element encoding logic comprising encoding logic for encoding only marked HTML form elements for the HTML form submission.

24. The computer-program product of claim 23, wherein the delta encoding logic further comprises clearing of marked state upon HTML form submission.

25. An apparatus comprising:
means for receiving delta encoded HTML form data from an HTML form submission over HTTP, wherein the delta encoded HTML form data comprises an encoded version of only HTML form elements of a complete HTML form that are changed by a user prior to the HTML form submission; and
means for reconstituting the complete HTML form using the delta encoded HTML form data.

26. The apparatus of claim 25, further comprising means for decoding the delta encoded HTML form data.

27. The apparatus of claim 25, further comprising means for preserving a state of the complete HTML form between HTML form submissions.

28. The apparatus of claim 27, further comprising:
means for modifying the preserved state of the complete HTML form with each delta encoded form element to replace its preserved counterpart so as to reconstitute the complete HTML form; and
means for making the reconstituted complete HTML form available for application-specific processing.

29. The apparatus of claim 28, further comprising means for transmitting a modified HTML page comprising logic for performing delta encoding of HTML forms, wherein only HTML form elements that are changed by the user prior to submission of the HTML form are encoded in the HTML form submission.

30. The apparatus of claim 29, wherein the delta encoding logic comprises code configured to cause a browser to:
preserve a state of local HTML form data between HTML form submissions;
compare preserved HTML form elements with their counterpart in the submitted HTML form;
encode only form elements that are different to generate the delta encoded HTML form data; and
transmit the delta encoded HTML form data.

31. The apparatus of claim 30, wherein the delta encoding logic comprises:
change detection and marking logic comprising event handling logic for individual HTML form elements, wherein each changed HTML form element is marked for delta encoding; and
marked HTML form element encoding logic comprising encoding logic for encoding only marked HTML form elements for the HTML form submission.

32. The apparatus of claim 31, wherein the delta encoding logic further comprises clearing of marked state upon HTML form submission.
